(19) United States
(12) Patent Application Publication
(10) Pub. No.: US 2005/0114184 A1
(43) Pub. Date: May 26, 2005

(54) Insurance coverage system and method

(76) Inventor: Brian Rock, Bellevue, WA (US)

Correspondence Address: BLACK LOWE & GRAHAM, PLLC, 701 FIFTH AVENUE, SUITE 4800, SEATTLE, WA, 98104, US

(21) Appl. No.: 10/993,781

(22) Filed: Nov. 20, 2004

Related U.S. Application Data
(60) Provisional application No. 60/524,144, filed on Nov. 21, 2003.

(51) Int. Cl. G06F 17/60

(52) U.S. Cl. 705/4

(57) ABSTRACT

Methods and systems for providing and servicing timeshare ownership packages. A user using a computer accesses a user interface provided by a server over a network. The user submits ownership information of a user's timeshare ownership via the user interface. A quote is automatically generated for an insurance policy of the user's timeshare ownership package based on the received ownership information and presented to the user. The user can purchase the quoted policy and if it is purchased a provider of the policy is compensated. The quote is based on one of days of ownership, points of ownership, or maintenance dues.

### BACKGROUND OF THE INVENTION

There presently does not exist comprehensive travel, commercial, or personal insurance geared specifically for Timeshare/Vacation Ownership exposures. One carrier has adapted regular travel insurance for Timeshare use. Another application gives some coverage for maintenance dues and exchange, but fails to consider property damage and liability issues. Furthermore, they have a pre-established value to the timeshare travel plan policy, and it is bought “pre-trip”. As a result, Timeshare/Vacation owners are still confused, because their vacation is pre-paid, meaning it doesn't really have a value to base a dollar limit against, as with regular travel insurance. All they know is how much vacation time they own and/or get to use. Therefore, there is a need for systems and methods for providing an easy to use, accurate Timeshare/Vacation Ownership insurance and travel plan protection.

### SUMMARY OF THE INVENTION

An embodiment of the present invention includes systems and methods system for evaluating, servicing, and/or providing a consumer insurance and travel insurance product that addresses specific insurance needs relating to loss or assistance that can happen with Timeshare/Vacation Ownership, lease, use, or rental which is not available or not bundled into a single system or object for evaluation, purchase, or service, and provides the consumers of Timeshare/Vacation Ownership or similar travel with comprehensive and cost effective insurance and travel benefits, recognizing certain processes within this invention can also be used for vacations insurance and assistance outside of Timeshare/Vacation Ownership, the system utilizing apparatus via the World Wide Web or communication systems, in addition to mail, phone fax or telecommunications.

### BRIEF DESCRIPTION OF THE DRAWINGS

The preferred and alternative embodiments of the present invention are described in detail below with reference to the following drawings. Certain steps are optional and the diagrams are meant to give a conceptual process that can be modified accordingly from technology changes or improvements, as well as process modifications, while staying within the core concept and unique processes of the invention.

FIG. 1 is a diagram of an example system formed in accordance with the present invention;

FIGS. 2-4 are flow diagrams of exemplary processes performed by the system shown in FIG. 1; and

FIGS. 5-20 are example screen shots of a network-based user interface for performing the processes of FIGS. 2-4.

### DETAILED DESCRIPTION OF THE EMBODIMENTS OF THE INVENTION

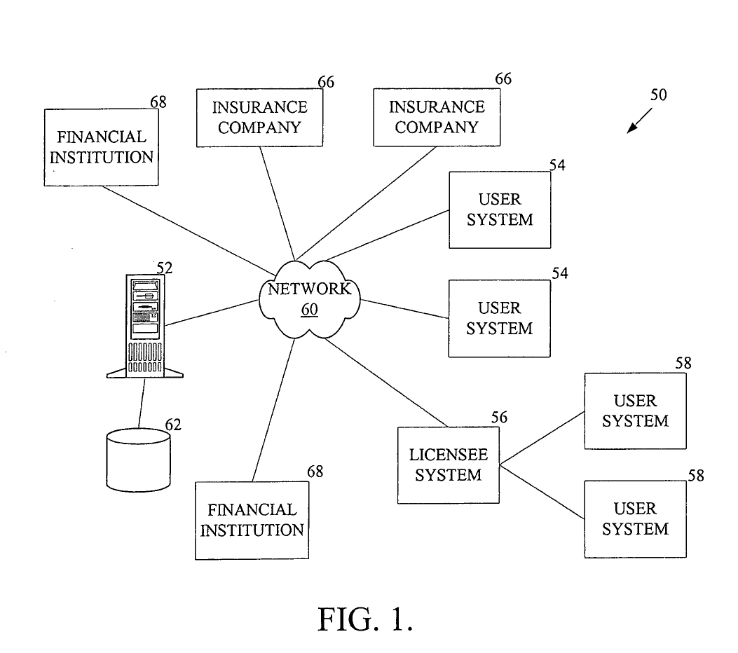

FIG. 1 illustrates a system 50 for buying and servicing the insurance policy and related benefits. The system 50 is formed in accordance with an embodiment of the present invention. The system 50 includes a processing device 52 that hosts a user interface/webpage that is accessible by user systems 54 and licensing systems 56 via a public or private data network 60. Insurance company systems 66 and financial institutions system 68 are also in data communication with the device 52 via the network 60 or via some other public or private data network. A memory device 62 is in data communication with the device 52 either directly or indirectly. The memory device 62 stores a database that includes information associated with users and insurance policies. The memory device 62 may be distributed amongst various other components or systems across the network 60 or another network. The licensing systems 56 provide a gateway for multiple user systems 58 to communicate with the device 52 via the network 60. Processing performed by the device 52 may also be distributed across the network 60.

The device 52 allows users using any of the user systems 54, 56, or 58 to apply for, receive, and modify timeshare/vacation ownership insurance. The timeshare/vacation owner insurance policies are written or underwritten by one or more of the insurance companies 66 or other similar entities. Payment or credit to either one of the insurance companies 66, user systems 54 or 58, or the licensing systems 56 may occur through any of the financial institutions 68 or similar entities.

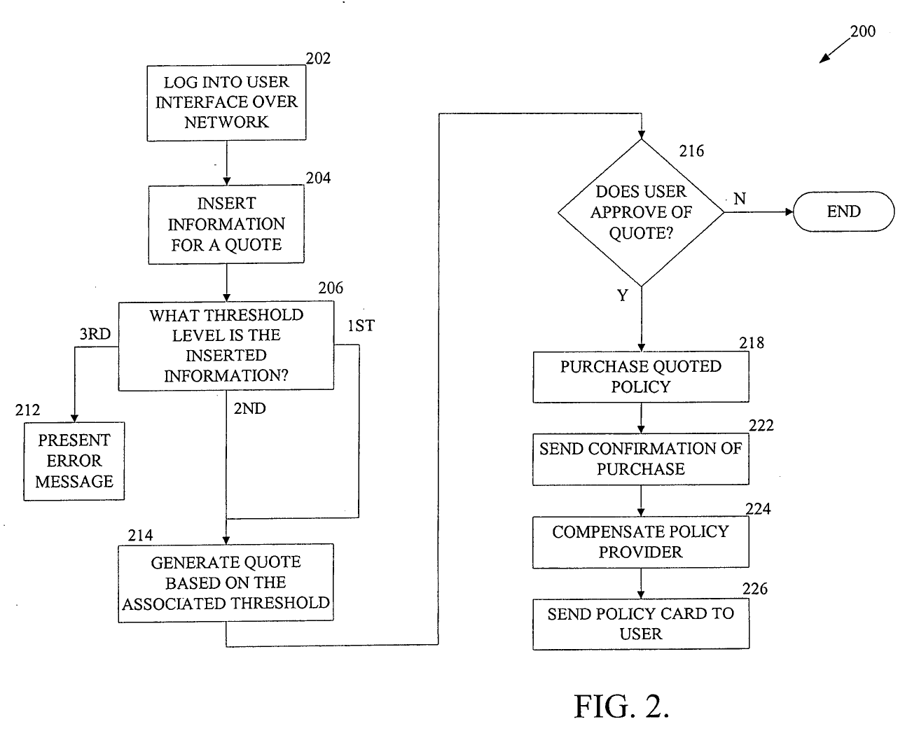

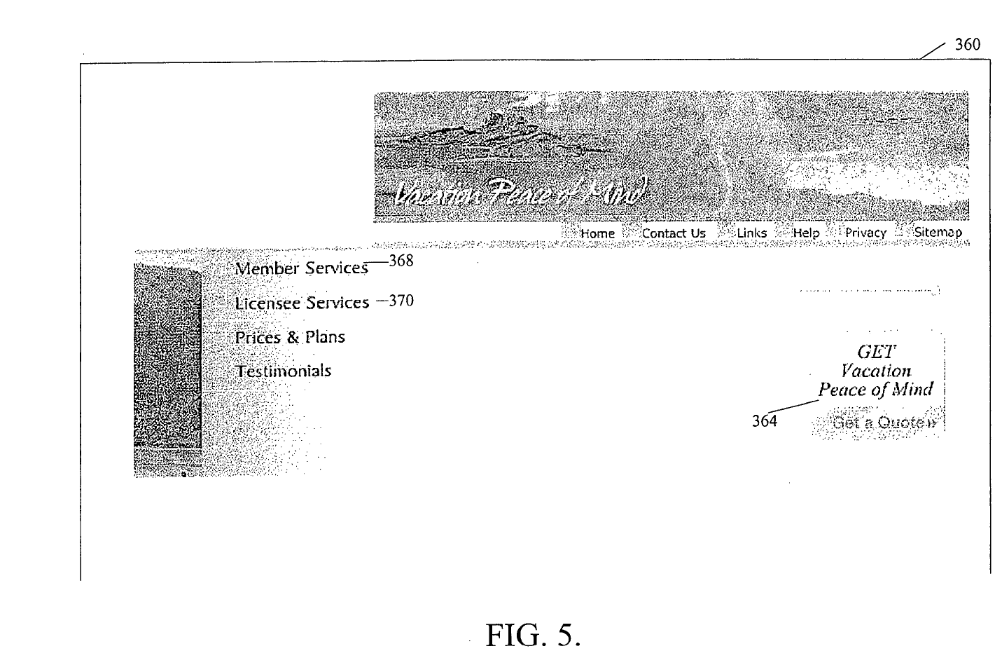

Other services are also provided by the user interface supported by the device 52, such as: claim submission, claim review, fraud reporting, policy renewal, policy review, policy editing and many other policy related matters. Processes performed by components of the system 50 are described in more detail below in flow diagrams FIGS. 2-4. An example network-based user application interface supported by the device 52 is illustrated in the screenshot shown in FIGS. 5-20.

An embodiment of the user device 52 is a computer-based server or similar device that can host a network-based user interface that includes multiple windows with hyperlinks for linking windows and fields for entering data. In another embodiment, the device 52 generates a software program that is transmitted to the devices 54, 56, or 58 and executed thereon as a user interface application. The user systems 54 and 58 include computer processing devices, such as a desktop, laptop, or palmtop computing devices, that include a wire and/or wireless link to the network 60. The network 60 may be a public and/or private data network, such as an intranet or the Internet. The licensing system 56 includes a computer-based processing device similar to the user system 54 or 58 that have secure interfaces with the device 52. The insurance company 66 and financial institution 68 may also include computing devices that are in communication with the device 52 over the network 60 or over another network. In one embodiment, the insurance companies 66 include insurance underwriters and/or other affiliates, such as third party claims or service providers or Third Party Administrators (TPA). The financial institutions 68 include any of a number of banks or creditor card providers that can hold or transfer money for the insurance companies 66, user systems 54 or 58 or licensing systems 56. Web-based financial transaction applications, such as PayPal™ allow users using the user systems 54, 56, or 58 to make payments via the network 60.

FIG. 2 illustrates an example process 200 performed by components of the system 50 shown in FIG. 1. First, at a block 202, a user logs into a user interface provided by the device 52 over the network 60. In one embodiment, the user logs on to a secure website supported by either one of the licensing system 56 that is directed to the user interface or components of the user interface supported by the device 52 or direct to the device 52. In another embodiment, the user is an anonymous user and the log-on process includes accessing an unsecure website supported by the device 52 using the system 54 or the licensing system 56.

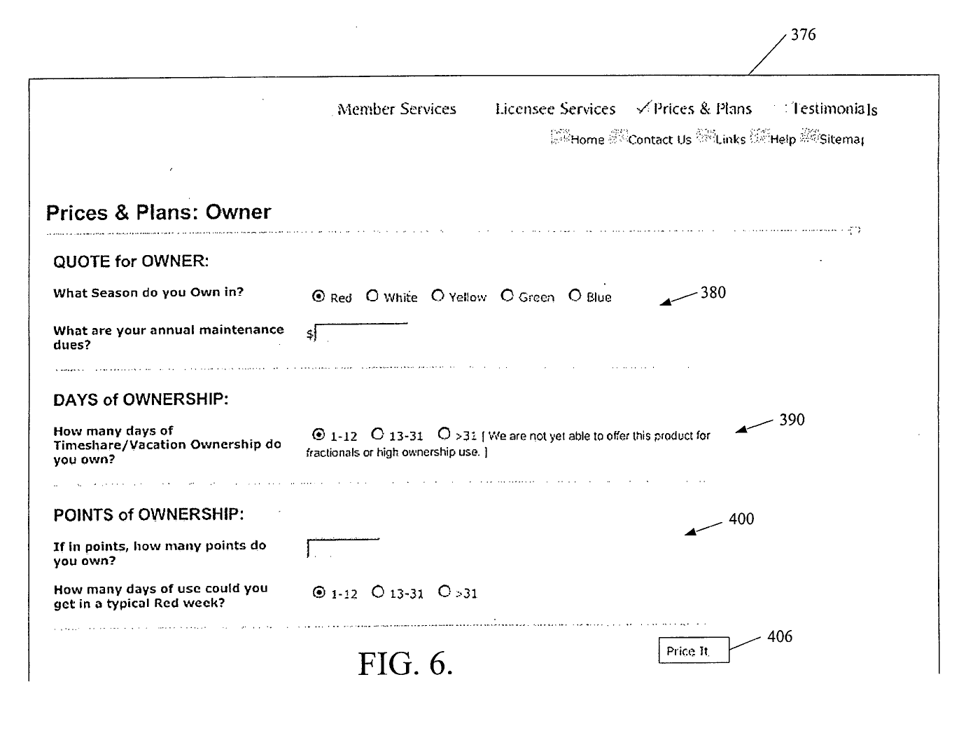

At block 204, the user inserts or selects from a displayed list timeshare/vacation ownership information into a price quote user interface page. The base information needed for a quote includes at least one of days of ownership, points, maintenance dues, lease value, or purchase price associated with their ownership, lease, rental, or use. The days of ownership or points of ownership are categorized into one of three different thresholds. An example threshold includes 1-12 days of ownership or the equivalent of 1-12 days of ownership with regard to points. A second threshold includes 13-31 days of ownership or 13-31 days of ownership equivalent of points of ownership. In this example, the third threshold is greater than 31 days of ownership or points that equate to more than 31 days of ownership. Other information that may be included in the information for a quote includes seasonal ownership information and annual maintenance dues related to the ownership. This is shown by example in more detail below in FIG. 6. More than 2 active thresholds may be included. Also, actual days or points of ownership information may be entered.

At a decision block 206, the process 200 determines of the inserted information is within the first, second, or third threshold. If it is determined that the information is within the first or second threshold, a quote is generated based on the associated threshold, see block 214. If the inserted information is not within the first or second threshold, then an error message is presented to the user, see block 212. If the inserted information is within either one of the first or second thresholds, then At a decision block 216, the process 200 asks for approval of the generated quote. If the user does not approve the generated quote, then the process 200 ends. If the user does approve the generated quote, the quote of the timeshare/vacation policy is purchased, see block 218. The purchase of the quoted policy may be performed a number of ways, for example, credit card information or other financial institution may be provided by the user to the device 52, whereby the device 52 debits the associated account information or bills the user or licensee in paper or electronic form. At a block 222, confirmation of the purchase policy is sent to the user. A confirmation email may be sent to an email address the user has applied to the device 52 and/or a confirmation letter may be sent to the user. At a block 224, the device 52 compensates the provider(s) of the policy that was issued to the user. Compensating the provider(s) of the policy can be performed in a number of ways, for example, credit can be applied to a financial account(s) associated with the policy provider(s). In another embodiment, any payments by a user or licensee may be applied directly to financial account(s) associated with the policy provider(s). Then, at a block 226, a policy card that is associated with a debit or other type of financial account is sent to the new policyholder. The use of this card is described in more detail below with regard to emergency funding for a claim.

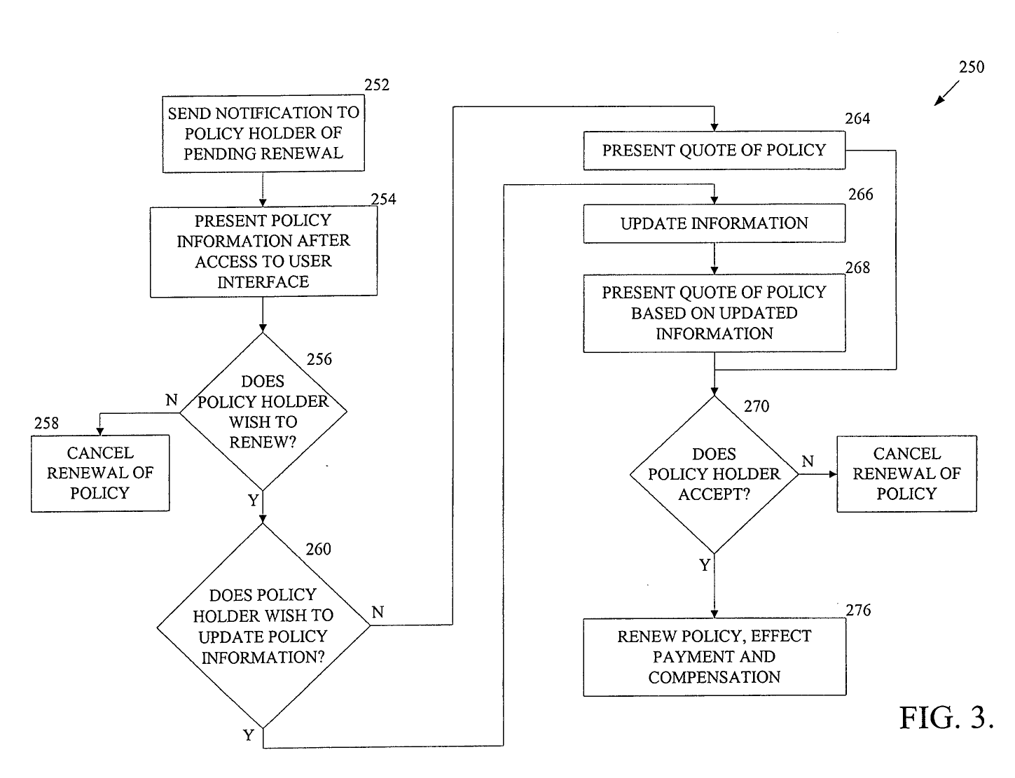

FIG. 3 illustrates a flow diagram of an example process 250 for allowing a user to renew an existing timeshare/vacation ownership policy that has been generated by the device 52. First, at a block 252, the device 52 sends notification to the policyholder of a pending renewal. The notification may be in many forms, such as an email transmission, facsimile transmission, or via regular mail. At a block 254, the policyholder accesses their policy information as stored in the database within the memory device 62 via the website supported by the device 52. At a decision block 256, the process 250 determines if the policyholder wishes to renew their timeshare/vacation policy. This is determined by an indication provided by the policyholder as to their intension. If the policyholder does not wish to renew, then at a block 258, the associated policy is scheduled to be cancelled at the renewal date. If the policyholder does wish to renew, then the process 250 determines at a decision block 260 if the policyholder wishes to update any information of the existing policy. If the policyholder does not wish to update any of the policy information, then at a block 264, the renewed policy quote is presented to the user. If at the decision block 260, the policyholder does wish to update the policy information, then at a block 266, the user enters any updated information and at a block 268, an updated quote is presented to the user based on the updated policy information. At a decision block 270, after the presentation of the quote with the updated information or just the renewed quote, the process 250 asks the policyholder if they accept the presented quote. If the policyholder does not accept the presented quote, then at a block 274, the timeshare/vacation policy of the user is cancelled at the renewal date. If the policyholder does accept the presented quote, then the policy is renewed, payment of the renewed policy is affected, and compensation to the policy provider occurs, see block 276.

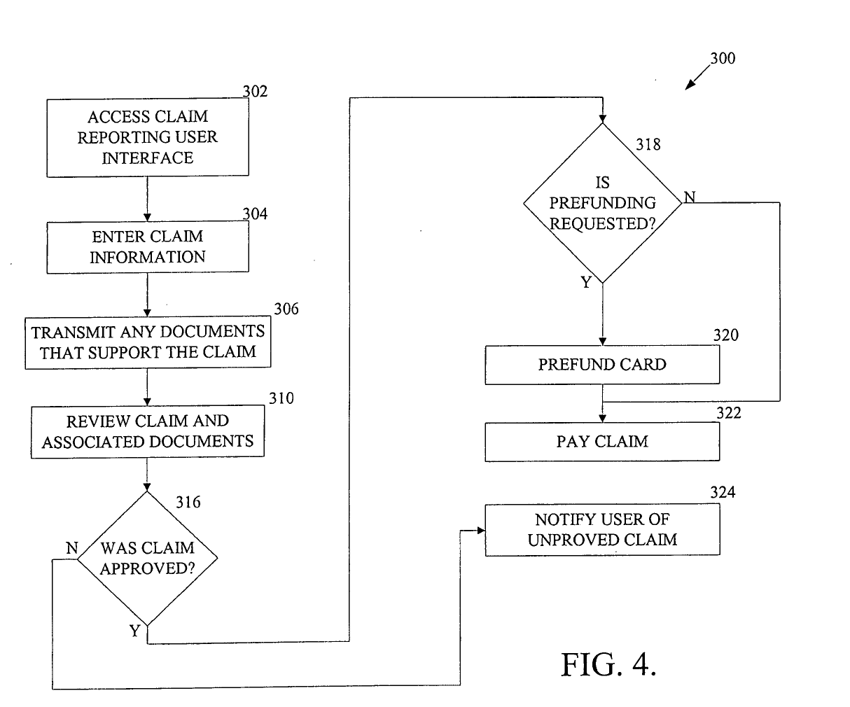

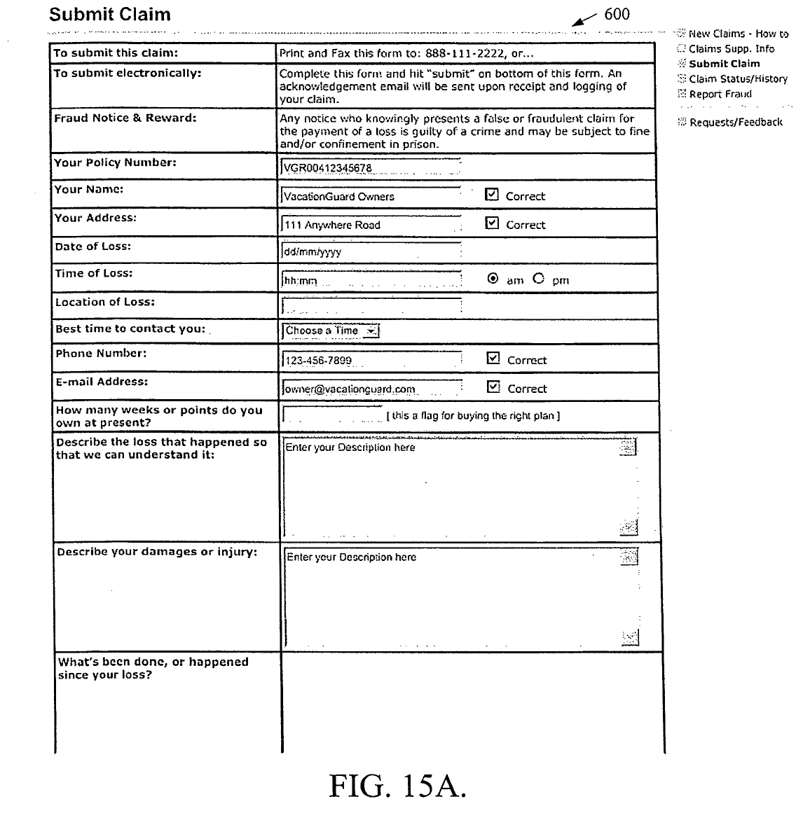

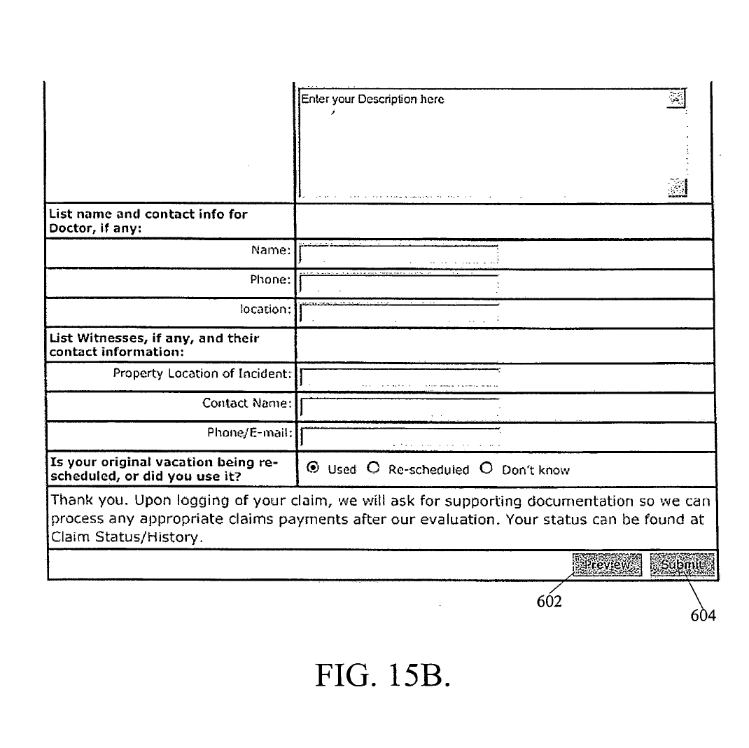

FIG. 4 illustrates a flow diagram of an example process 300 for allowing policyholders to make claims via the device 52. At a block 302, the policyholder accesses a secure claim reporting user interface that is provided by the device 52. At a block 304, the policyholder enters claim information. An example of the claim information is described in more detail below with regards to FIGS. 15A and B. At a block 306, the policyholder transmits any documents that are required for supporting the claim. Transmission of documents may be accomplished a number of ways, for example, the policyholder may fax the documents into a pre-specified facsimile number or may upload scans of the requested documents through an uploading interface included in the claim reporting user interface. At a block 310, the claim and associated documents are review to determine if they comply with the policy. At a decision block 316, the process 300 determines if the claim was approved. If the claim was approved at the decision block 316, then at a decision block 310, the process 300 determines if a pre-funding request was made by the policyholder. If the claim was not approved or rejected at the decision block 316, the user is notified that their claim was not approved, see block 324.

If a pre-funding request was made by the policyholder and if the associated timeshare/vacation policy supports pre-funding, then at a block 320 credit (or electronic refunds) is applied to an account associated with the policyholder or is applied to the policy card. The pre-funding of a claim may be provided to a policyholder a number of different ways, for example, crediting of a user financial account through any of the financial institutions 68 or by delivery of travel checks or other means for getting funds into the hand of the policyholder quickly. After pre-funding has occurred or pre-funding was not requested, the claim is paid, see block 322.

FIG. 5-20 illustrate example screen shots of various aspects of the user interface that are provided by the device 52 and accessible by users using user systems 58 or 56 or licensees using the licensing system 56. FIG. 5 illustrates a screen shot of an introductory page 360. The introductory page 360 includes hyperlink text that directs a user to a place where they can get a quote for a timeshare/vacation policy. The page 360 also includes a member services hyperlink 368 and a licensee services hyperlink 370. The member services hyperlink 368 directs users or policyholders to a secure log-in password accessible set of user interfaces associated with their policy. The licensee services hyperlink 370 allows secure access, but for a licensee via a licensing system 56. The information accessible by a licensee through the licensee services hyperlink 370 would include the information associated with all of the members/policyholders associated with the timeshare/vacation property affiliated with the licensee. The introductory page 360 also includes a quote hyperlink 364 that when activated retrieves and presents the page shown in FIG. 6.

FIG. 6 illustrates an example policy quote input page 376. Included within the policy quote input page 376 are fields for selections that allow a user to define their ownership interest in their timeshare/vacation ownership. A first section 380 includes a first subsection that allows a user to identify what season their property is owned in and if there are any maintenance dues associated with the property. A second section 390 allows a user to select how many days of timeshare/vacation ownership they own. The user, in this example, may select from one of the following three options:
1-12 days;
13-31 days; or
greater than 31 days.

The page 376 includes a third section 400 that allows a user to input the number of points associated with their timeshare/vacation ownership or the equivalent number of days related to the points that they own. After the user has entered their ownership information, the user selects a price it button 406. Upon section of the price it button 406, the entered information is processed by the device 52 for generation of a quote.

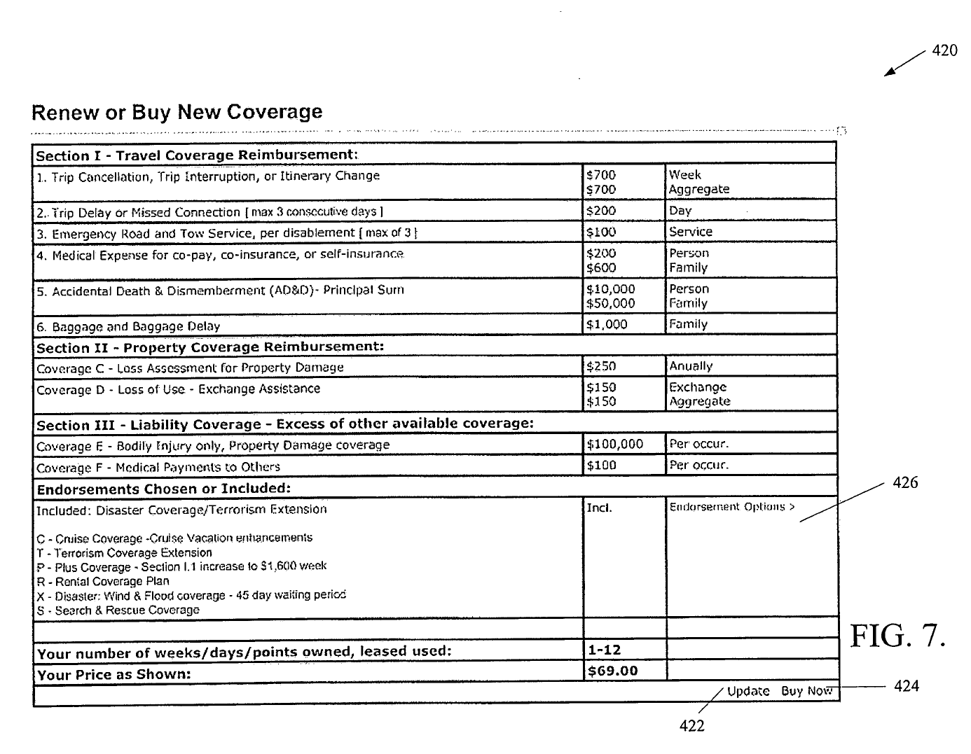

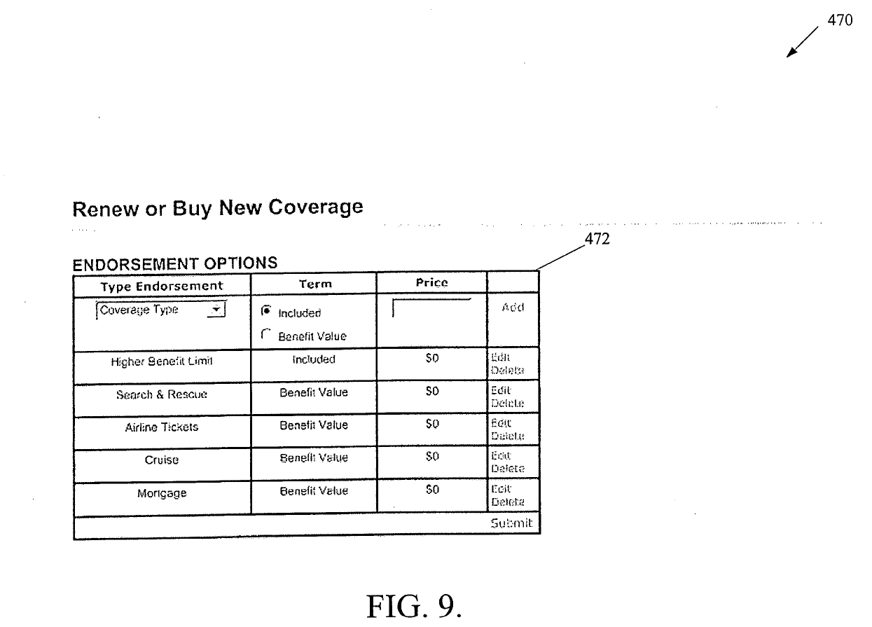

FIG. 7 illustrates an example page 420 that presents a quote to a user based on the information entered in the quote page 376. The quote in the page 420 includes a travel coverage reimbursement section (Section I), a property coverage reimbursement section (Section II), a liability coverage section (Section III), an endorsement section, an identification of the number of days selected from the quote page 376, and the price of the quoted policy. The endorsement section includes an endorsement options hyperlink 426 that when selected by the user allows a user to select from various endorsement options. Examples of endorsement options are shown by example in FIG. 9 below. The page 420 also includes a hyperlink update button 422, and a buy now button 424. A user selects the update button 422 if they have selected or changed some of the endorsement options after have selected the endorsement options hyperlink 426. If the user selects the buy now button 424, the purchase of the presented policy begins.

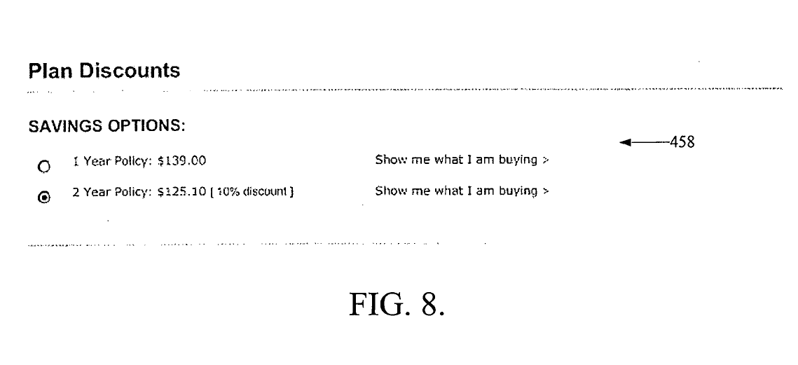

FIG. 8 illustrates a savings options page 458. The page 458 is a user interface that allows the user to select a 2-year payment option or a single year payment option. Other payment plans may be provided.

FIG. 9 illustrates an endorsement options page 470 that presents an endorsement options table that allows the user to select one or a number of various endorsement options associated with the timeshare/vacation ownership policy. In one embodiment, the endorsement options page 470 is presented upon user activation of the endorsement options hyperlink 426 of page 420.

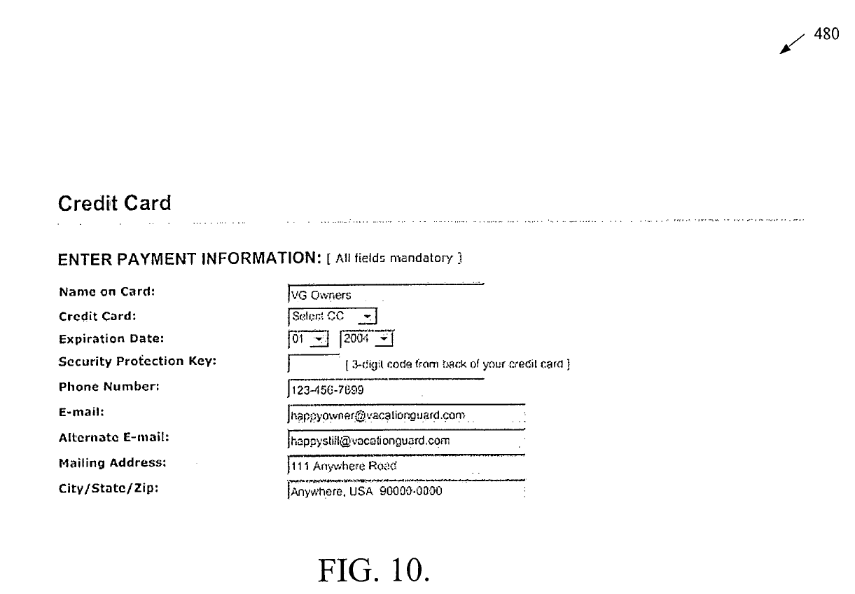

FIG. 10 illustrates a payment page 480 that includes fields that allow a user to enter various information in order to pay for the policy. In this example, credit card information is the information that a user enters into the fields included in the payment page 480. Upon entry of the information into the payment 480, a timeshare/vacation policy is created and purchased based on all the previously entered information.

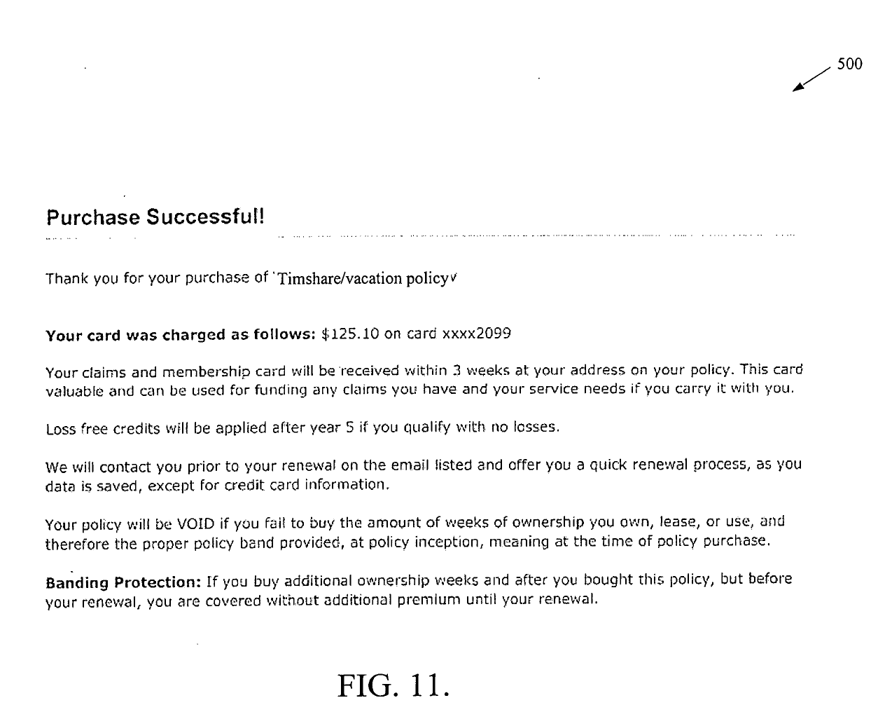

FIG. 11 illustrates a purchase confirmation page 500 that is presented to the user upon successful completion of the financial transaction that was initiated at the page 480. The page 500 indicates various information associated with the purchase policy and how much was charged or debited from the associated financial account. The purchase confirmation page 500 may also be presented to the user in the form of an email or a hard copy via mail.

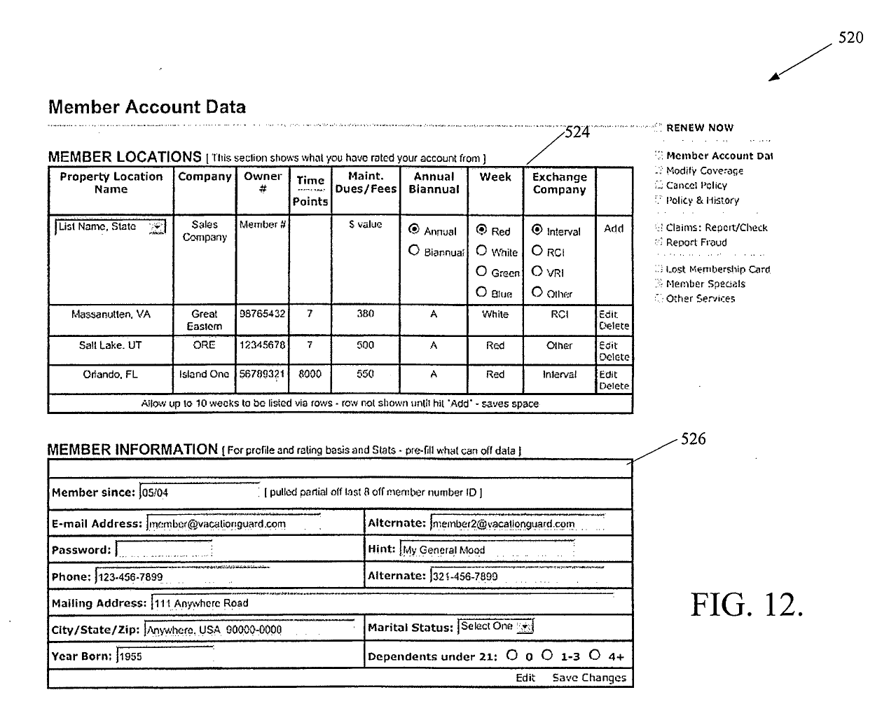

Upon completion of the purchase process, the user is provided with password information to allow the user to log on to a password protected website that is executed and run by the device 52. Once the user has logged into the secured website using the password information, a member account data page 520 is presented, see FIG. 12. The member account data page 520 includes a member location information 524 and a member information section 526. The member location section 524 lists all the timeshare/vacation property covered by the timeshare/vacation ownership policy. The member information section 526 includes various fields that present information of the member.

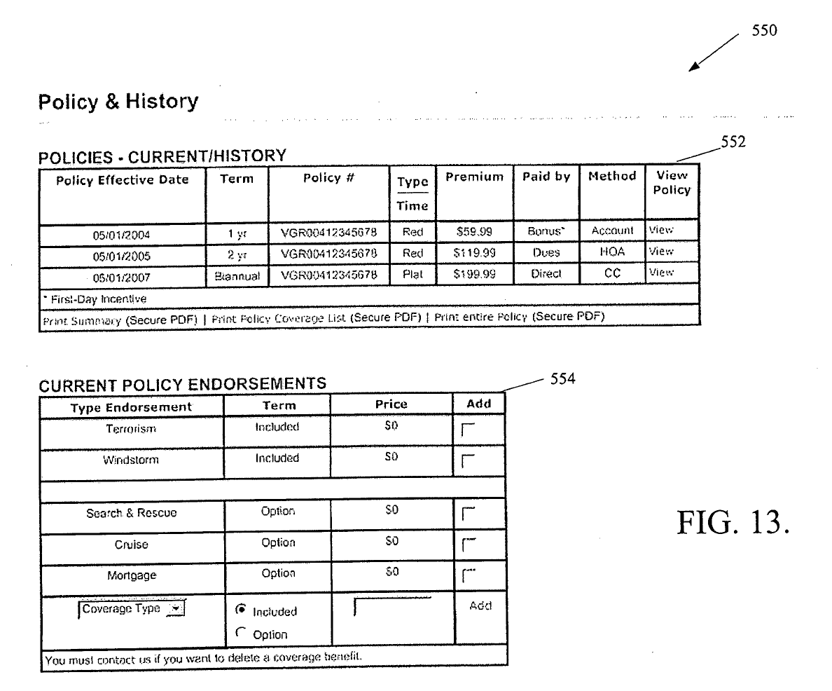

FIG. 13 illustrates a policy and history page 550 also accessible by a member through secure access. The policy and history window 550 includes a current/historical policy information section 552 and a current policy endorsements section 554. Policy history information for the member is presented in the current/historical policy information section 552. Endorsements that are presently in effect are presented in the current policy endorsements section 554.

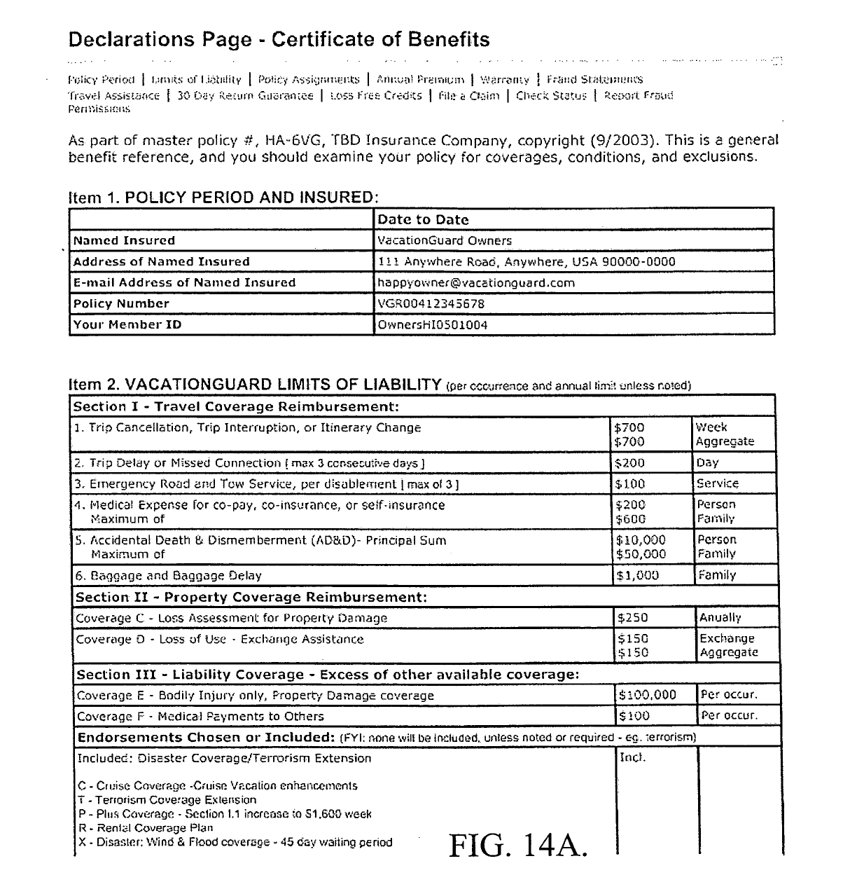

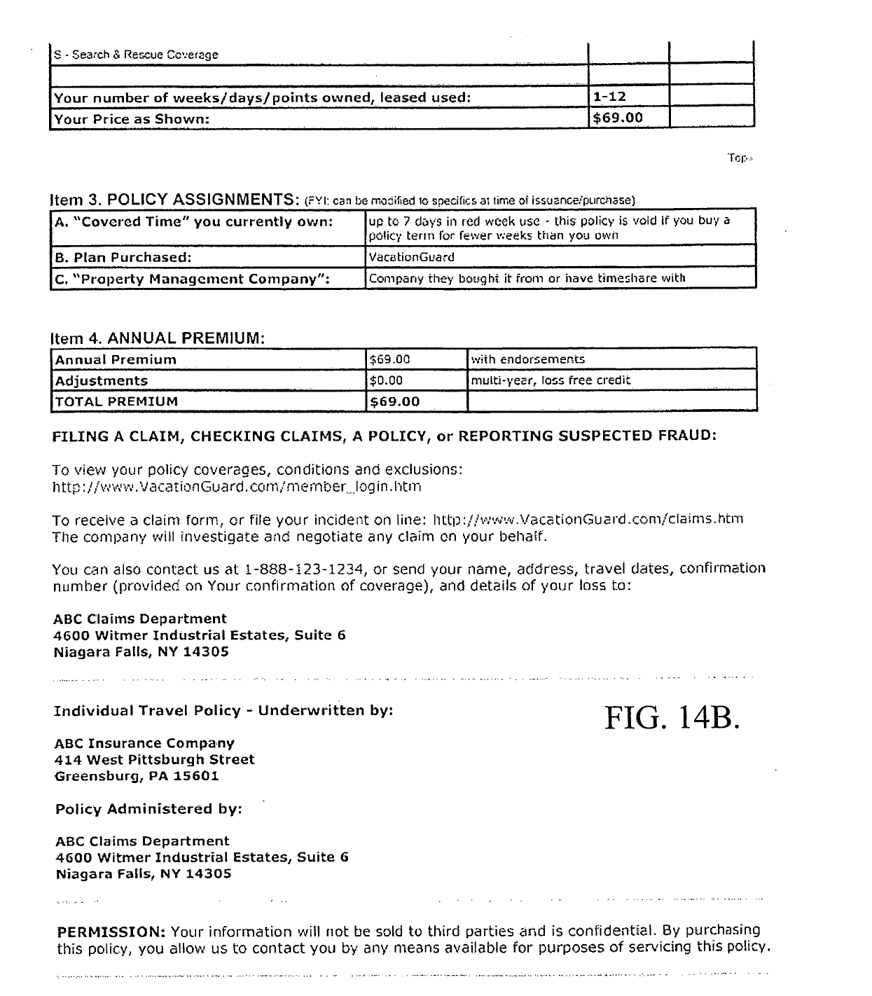

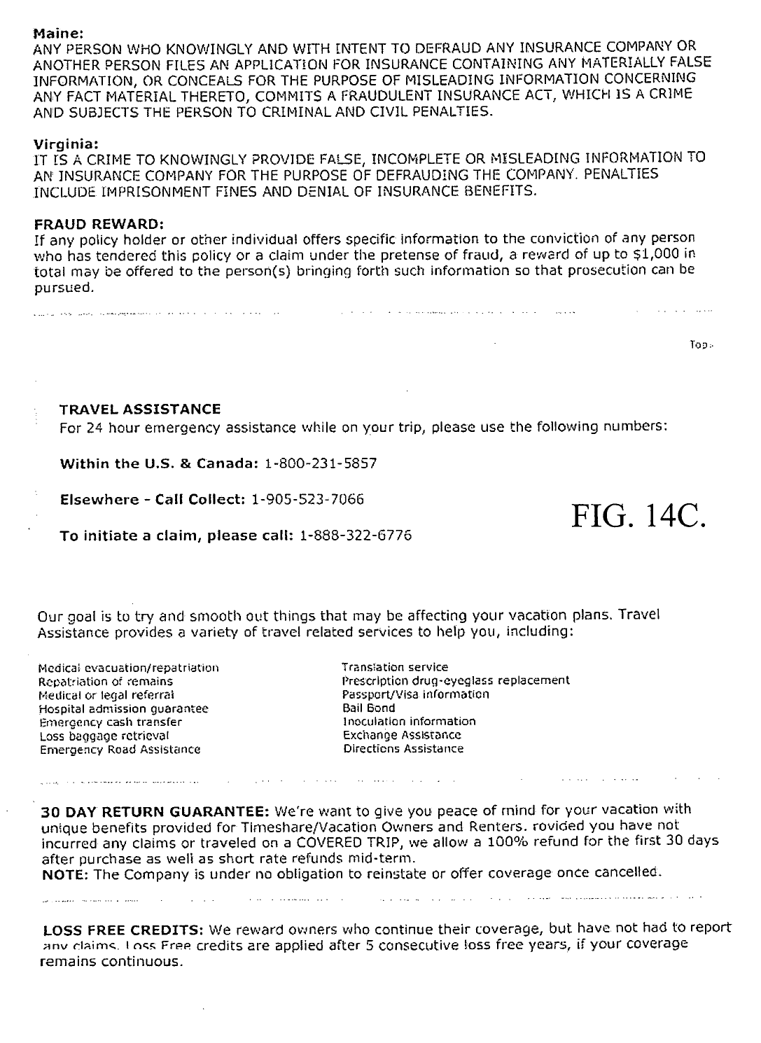

FIGS. 14A-C illustrate details about benefits and other information associated with the member's policy.

FIGS. 15A and B illustrate a submit claims page 600. The submit claims page 600 allows a member to submit information related to a claim. The submit claim page 600 includes a preview button 602 and a submit button 604. Upon selection of the preview button 602, the member can view the claim information that they entered within the submit claim window 600. After selection of the submit button 604, a claim is submitted and processing of that claim is performed by claim adjusters associated with either one of the devices 52 or insurance company 66 associated with the members timeshare/vacation policy.

FIG. 16 illustrates a claims history page 650. The claims history page 650 indicates the history of claims that the member has made.

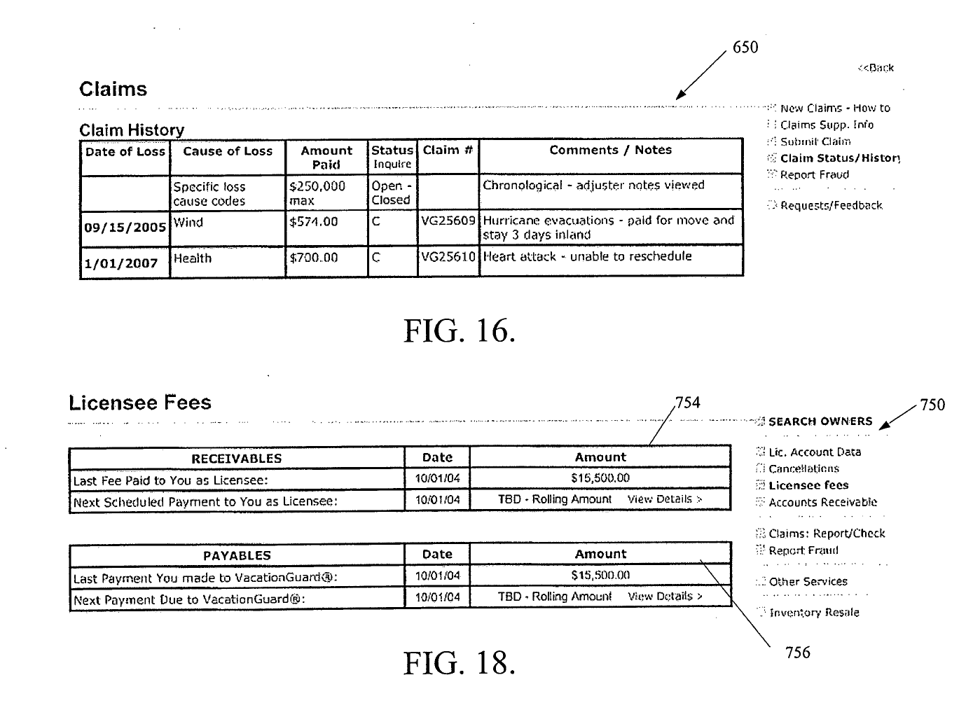

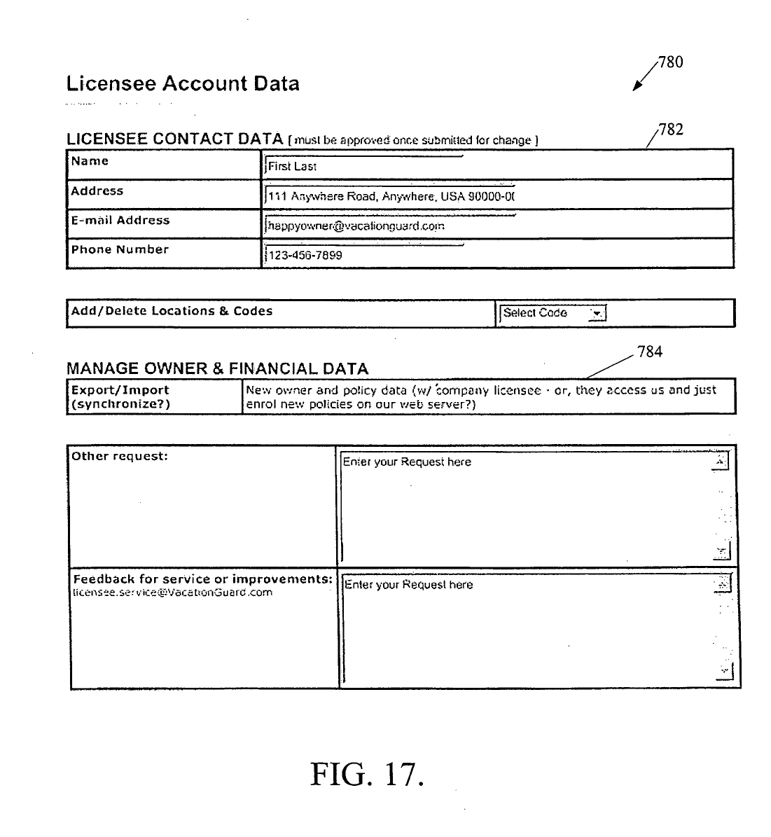

FIG. 17 illustrates a licensee account data page 700. The licensee account data page 700 includes a licensee contact data information section 702 and a financial data section 704. In one embodiment, the licensee account data page 700 is accessed by a licensee entering their password after selection of the licensee services hyperlink 370 (FIG. 5).

FIG. 18 illustrates a licensee fees page 750. The licensee fees page 750 includes a receivable section 752 and a payable section 754. The receivable section 752 and the payable section 754 present accounting information for the licensee as it relates to the associated policies.

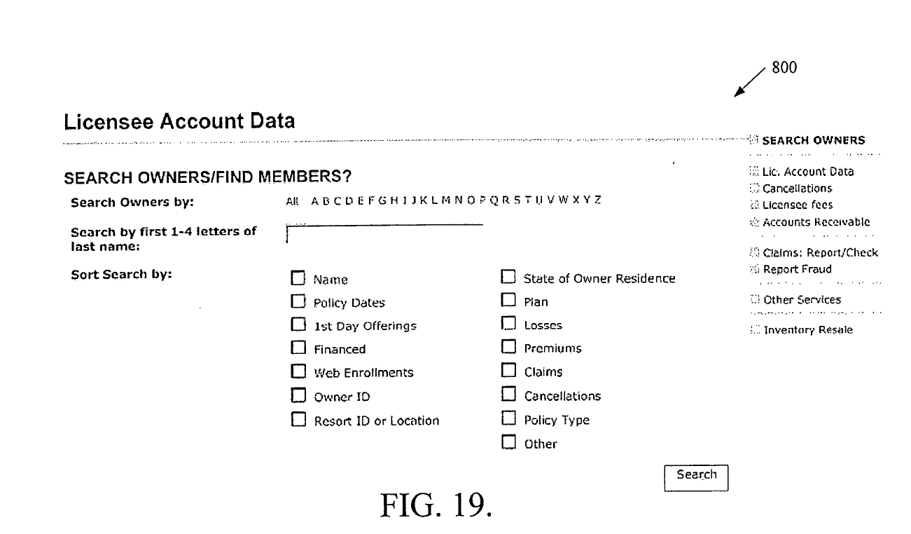

FIG. 19 illustrates a licensee member ownership search page 800. The search page 800 allows the licensee to search the database of members associated with the licensee based on the various number of different search criteria.

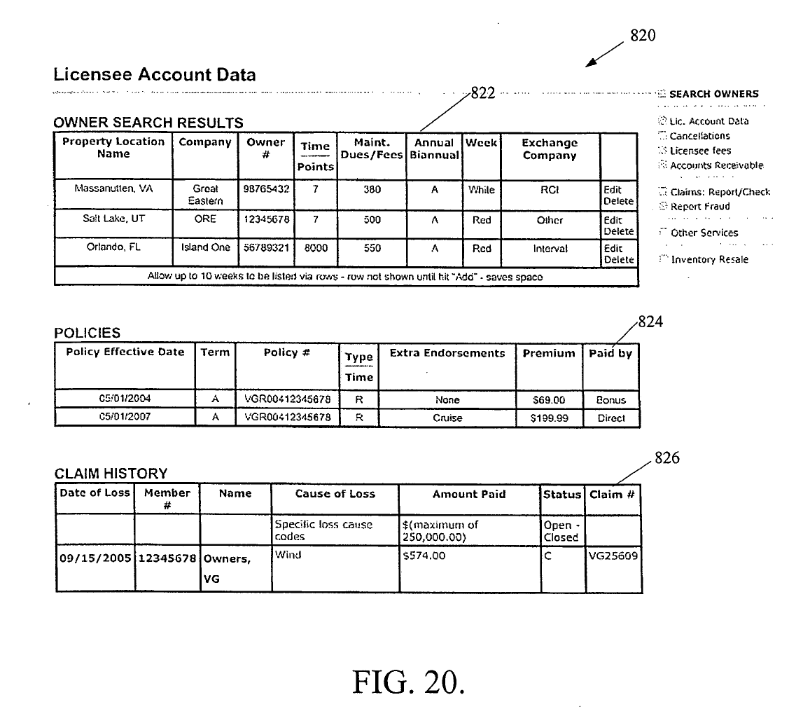

FIG. 20 illustrates an exemplary search results page 820 that is presented after entry of certain search criteria from the search page 800 shown in FIG. 19. The results page 820 includes a search results section 822 that shows results of the search. A policies section 824 presents policy information associated with the results of the search. A claim history section 826 presents claim information associated with the results of the search.

The following is an example of the rating for a timeshare/vacation policy. In this example, the policy is rated by days or points of ownership. For example, some Timeshare entities give you a real estate deed for your proportional unit interest. Other Timeshare entities hold the deed in a trust, and issue “points” associated with the use of time and units within the trust.

In this example an owner buys one week of Timeshare/Vacation Ownership in Orlando via deed. They now own 7 days. According to the threshold structure shown in FIG. 6, the policy is based on a first band—for the initial release at 1-12 days.

In another example, an owner owns one week of timeshare in Orlando via deed, and decides to buy another week via deed when they go to Hawaii. They now own 14 days. Thus, the policy would be based on the second band—for the initial release at 13-31 days.

In a third example, an owner buys one week of Timeshare/Vacation Ownership in Orlando via points—they are given 10,000 points. They now own 10,000 points, which equates to 7 days in high season (red week). Thus, the policy would be based on the first band—for the initial release at 1-12 days or points of value.

In a fourth example, an owner owns one week of timeshare in Orlando via points, and decides to buy another week via points when they go to Hawaii. They now own 20,000 points, which equates to 14 days in high season (red week). Thus, the policy would be based on the second band—for the initial release at 13-31 days.

In a fifth example, an owner owns one week of timeshare in Orlando via deed, and decides to buy another week via points when they go to Hawaii. They now own 7 days in one place, and 10,000 points (or 7 days in high (red) season), which equates to 14 days ownership in high season (red week). Thus, the policy would be based on the second band—for the initial release at 13-31 days.

The following illustrates how a policy may be adjusted based on Maintenance Fees. In a first example, if the total maintenance fees are less than $1500, the price for the policy is 1.0 of a base rate for the same benefits. In these examples, assume the base rate is $69 annual fee for the policy. If the total maintenance fees are $1501-$400, the price of the policy is 1.8 of the base rate. If the total maintenance fees are greater than $4001, the price of the policy is 5.0 or some other factor of the base rate, if offered at all.

The user enters their maintenance dues for the rating basis parameter, or picks from ranges of maintenance dues via a drop down box or some other method, and the calculated rate is presented.

While the preferred embodiment of the invention has been illustrated and described, as noted above, many changes can be made without departing from the spirit and scope of the invention. For example, the steps of the processes described above may be performed in a different order without departing from the scope of the invention. Accordingly, the scope of the invention is not limited by the disclosure of the preferred embodiment. Instead, the invention should be determined entirely by reference to the claims that follow.

1. A method comprising:
receiving ownership information of one or more timeshare owners packages;
automatically generating a quote for one or more insurance policies of the one or more timeshare owners packages based on the received information;
transmitting the generated quote over a network to a computer device associated with the user;
purchasing the quoted policy, if a purchase request was received;
compensating a provider of the policy,
wherein the ownership information includes at least one of days of ownership, points of ownership, maintenance dues, lease value, purchase price, rental value, unit values, time, liability, or real estate value.

2. The method of claim 1, wherein automatically generating a quote is based on a plurality of ranges of the ownership information.

3. The method of claim 2, wherein automatically generating a quote generates a first quote if the days of ownership are within a first range and a second quote if the days of ownership are within a second range.

4. The method of claim 3, wherein the first range is 1-12 days and the second range is 13-31 days.

5. The method of claim 4, wherein automatically generating a quote generates an error message if the days of ownership are within a third range.

6. The method of claim 3, wherein automatically generating the first and second quotes are modified based on the maintenance dues.

7. The method of claim 2, wherein automatically generating a quote generates a first quote if the points of ownership are within a first range and a second quote if the points of ownership are within a second range.

8. The method of claim 7, wherein the first range equates to 1-12 days and the second range equates to 13-31 days.

9. The method of claim 8, wherein automatically generating a quote generates an error message if the points of ownership equate to a value greater than the second range.

10. The method of claim 7, wherein automatically generating the first and second quotes are modified based on the maintenance dues.

11. The method of claim 2, wherein automatically generating a quote generates a first quote if a combination of the days and points of ownership are within a first range and a second quote if the combination of the days and points of ownership are within a second range.

12. The method of claim 11, wherein the first range is 1-12 days and the second range is 13-31 days.

13. The method of claim 12, wherein automatically generating a quote generates an error message if the combination of the days and points of ownership are greater than the second range.

14. The method of claim 11, wherein automatically generating the first and second quotes are modified based on the maintenance dues.

15. The method of claim 1, wherein purchasing includes at least one of sending a bill to the user or charging at least one of a credit card, a debit card, or a financial account associated with a user that performed the purchase request.

16. The method of claim 1, wherein compensating a provider includes applying a monetary credit or value to a financial account associated with the provider.

17. A computer-based system comprising:
a processing component comprising:
a network communication component for providing data communication with one or more data networks;
a user interface component accessible to user computer systems over a data network via the network communication component, the user interface component comprising:
a first component for receiving ownership information of a user's timeshare ownership package;
a second component for automatically generating a quote for an insurance policy of the user's timeshare ownership package based on the received ownership information;
a third component for transmitting the generated quote to a user computer system over the data network via the network communication component, wherein the user computer system is associated with user of the received ownership information;
a fourth component for executing a purchase of the quoted policy, if a purchase request was received;
a fifth component for compensating a provider of the policy based on the executed purchase,
wherein the ownership information includes at least one of days of ownership, points of ownership, maintenance dues, lease value, purchase price, rental value, unit values, time, liability, or real estate value.

18. The system of claim 17, wherein the second component automatically generates a quote based on a plurality of ranges of the ownership information.

19. The system of claim 18, wherein the second component automatically generates a first quote if the days of ownership are within a first range and a second quote if the days of ownership are within a second range.

20. The system of claim 19, wherein the first range is 1-12 days and the second range is 13-31 days.

21. The system of claim 20, wherein the second component generates an error message if the days of ownership are within a third range.

22. The system of claim 19, wherein the second component modifies the first and second quotes based on the maintenance dues.

23. The system of claim 18, wherein the second component generates a first quote if the points of ownership are within a first range and a second quote if the points of ownership are within a second range.

24. The system of claim 23, wherein the first range equates to 1-12 days and the second range equates to 13-31 days.

25. The system of claim 24, wherein the second component generates an error message if the points of ownership equate to a value greater than the second range.

26. The system of claim 23, wherein the second component modifies the first and second quotes based on the maintenance dues.

27. The system of claim 18, wherein the second component generates a first quote if a combination of the days and points of ownership are within a first range and a second quote if the combination of the days and points of ownership are within a second range.

28. The system of claim 27, wherein the first range is 1-12 days and the second range is 13-31 days.

29. The system of claim 28, wherein the second component generates an error message if the combination of the days and points of ownership are greater than the second range.

30. The system of claim 27, wherein the second component modifies the first and second quotes based on the maintenance dues.

31. The system of claim 17, wherein the fourth component includes at least one of sending a bill to the user or charging one of a credit cardm a debit card, or a financial account associated with a user that performed the purchase request.

32. The system of claim 17, wherein the fifth component includes applying a monetary credit or value to a financial account associated with the provider.
